(19) United States
(12) Patent Application Publication
(10) Pub. No.: US 2026/0024183 A1
(43) Pub. Date: Jan. 22, 2026

(54) DRIVER ASSISTANCE SYSTEM

(71) Applicant: Harman Becker Automotive Systems GmbH, Karlsbad (DE)

(72) Inventors: Roei Eliazov, München (DE); Anilkumar Hariharakrishnan, Sauerlach (DE)

(21) Appl. No.: 19/344,261

(22) Filed: Sep. 29, 2025

Related U.S. Application Data
(63) Continuation of application No. 18/346,729, filed on Jul. 3, 2023.

(30) Foreign Application Priority Data
Jul. 4, 2022 (EP) 22 182797

(51) Int. Cl. G06T 5/80; B60Q 9/00; B60R 1/28; G06V 20/58; G06V 20/59; H04N 23/695

(52) U.S. Cl. CPC G06T 5/80; B60Q 9/008; B60R 1/28; G06V 20/58; G06V 20/597; B60R 2300/30; G06T 2207/30261; G06T 2207/30268; H04N 23/695

(57) ABSTRACT

A driver assistance system for a vehicle, the driver assistance system comprising a camera mounted on the vehicle and configured to capture one or more images inside and/or outside of the vehicle, and a processing unit, wherein the camera has a defined field of view (FOV), the camera comprises an optical lens that causes a distortion of the captured images, the processing unit is configured to perform distortion compensation on the images captured by the camera, wherein a pixel density in the resulting compensated images is increased in defined areas of the image due to the distortion, and the defined areas of increased pixel density in the compensated images correspond to a region of interest (ROI) within the image, wherein the ROI is smaller than the FOV of the camera.

### CROSS REFERENCE TO RELATED APPLICATIONS

The present application is a continuation-in-part of U.S. Non-provisional patent application Ser. No. 18/346,729 filed Jul. 3, 2023 and entitled “DRIVER ASSISTANCE SYSTEM”, which claims priority to European Patent Application No. 22182797.5, filed on Jul. 4, 2022. The entire contents of the above-listed applications are hereby incorporated by reference for all purposes.

### TECHNICAL FIELD

The disclosure relates to a driver assistance system, in particular to a camera-based driver assistance system.

### BACKGROUND

Driver assistance may include any relief that is provided to an individual associated with a vehicle with the aim of increasing individual protection and enhancing driver experience. Driver assistance systems including outward facing cameras may be configured to enhance a driver's awareness by providing detailed information about the vehicle's environment that may not be apparent to the driver. Images that are captured by means of one or more outward facing cameras may be displayed on a display of the vehicle, for example. Alternatively, it is also possible to analyze the images captured with outward facing cameras and identify any potentially dangerous obstacles in the surroundings of the vehicle. If any obstacles are identified, a warning may be generated that may be perceived by the driver of the vehicle. Other driver assistance systems include inward facing cameras. Inward facing cameras may capture images of a driver or any other occupants of the vehicle, for example. Such driver assistance systems may be configured to detect a driver's attention or drowsiness level, for example, by evaluating the images captured by the inward facing cameras. Driver fatigue is a major cause of road accidents in general, and in particular of severe road accidents. Therefore, driver fatigue has a huge impact on road safety. Drivers may be drowsy when driving at night or in the early morning, towards the end of a long journey, or for any other reason. Many advanced driver assistance systems (ADAS) monitor a driver's attention level/drowsiness level and generate a warning if it is detected that the attention level decreases and/or the drowsiness level increases. A driver's attention or drowsiness level can be detected by a camera-based driver assistance system by monitoring driver parameters such as a duration of eyelid closure and/or a frequency of eyelid closure, for example. Vehicles may also be equipped with computing systems that use inward facing cameras for detection of occupant hand gestures, such as for control of a vehicle head unit. There is a need for a camera-based driver assistance system (including inward and/or outward facing cameras) and related method that are able to reliably detect any obstacles and/or to reliably detect any changes of driver parameters or gestures that are monitored by the system, in order to increase road safety and detection of occupant gestures.

### SUMMARY

A driver assistance system of the present disclosure can be used for a vehicle and includes a camera mounted on the vehicle and configured to capture one or more images inside and/or outside of the vehicle, and a processing unit, wherein the camera has a defined field of view, the camera includes an optical lens that causes a distortion of the captured images, the processing unit is configured to perform distortion compensation on the images captured by the camera, wherein a pixel density in the resulting compensated images is increased in defined areas of the image due to the distortion, and the defined areas of increased pixel density in the compensated images correspond to a region of interest within the image, wherein the region of interest is smaller than the field of view of the camera.

The present disclosure further provides a method. The method includes capturing one or more images inside and/or outside of a vehicle by means of a camera mounted on the vehicle, wherein the camera has a defined field of view, and the camera includes an optical lens that causes a distortion of the captured images, and performing distortion compensation on the images captured by the camera by means of a processing unit, wherein a pixel density in the resulting compensated images is increased in defined areas of the image due to the distortion, and the defined areas of increased pixel density in the compensated images correspond to a region of interest within the image, wherein the region of interest is smaller than the field of view of the camera.

Other systems, methods, features and advantages of the present disclosure will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The arrangement may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a vehicle with a plurality of cameras mounted thereon.

FIG. 2 schematically illustrates different examples of radial distortions.

FIG. 3 schematically illustrates a field of view of an exemplary camera and a region of interest within the field of view.

FIG. 4 schematically illustrates the resulting pixel densities within the field of view for different radial distortions.

FIG. 5 schematically illustrates a driver assistance system according to one embodiment of the present disclosure.

FIG. 6 illustrates a flow chart of a method according to one embodiment of the present disclosure.

FIG. 7 schematically illustrates a second driver assistance system according to one embodiment of the present disclosure.

FIG. 8 illustrates exemplary fields of view of the second driver assistance system of FIG. 7.

FIG. 9 schematically illustrates a third driver assistance system according to one embodiment of the present disclosure.

FIG. 10 illustrates an exemplary field of view of the third driver assistance system of FIG. 9.

FIG. 11 illustrates a flow chart of a method according to one embodiment of the present disclosure.

FIG. 12 illustrates a flow chart of a method according to one embodiment of the present disclosure.

FIG. 13 illustrates a flow chart of a method according to one embodiment of the present disclosure.

### DETAILED DESCRIPTION

As required, detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that directional terms that may be noted herein (e.g., “upper”, “lower”, “inner”, “outer”, “top”, “bottom”, etc.) simply refer to the orientation of various components of an arrangement as illustrated in the accompanying figures. Such terms are provided for context and understanding of the disclosed embodiments.

The driver assistance systems and related methods according to the various embodiments described herein are able to reliably detect any obstacles and/or to reliably detect any changes of driver parameters that are monitored by the system in order to increase road safety.

Camera-based Advanced Driver Assistance Systems (ADAS), including Driver Monitoring Systems (DMS), Occupant Monitoring Systems (OMS), and external environment monitoring, rely on accurate visual capture for reliable operation. Conventional camera modules distribute pixel density uniformly across a camera's field of view (FOV). However, in real-world ADAS scenarios, the most useful information is concentrated in regions of interest (ROIs) such as the driver's face, driver or other occupant's hands, passenger seating areas, or road features like lanes and pedestrians. Uniform resolution leads to inefficient sensor use, while higher-resolution sensors add cost, bandwidth, and processing overhead.

Lens distortion, typically viewed as an optical artifact, has traditionally been corrected rather than exploited. Rolling shutter (RS) cameras aggravate distortion by capturing rows of pixels sequentially, introducing temporal artifacts such as skew, wobble, or motion blur, making intentional distortion control unreliable. Global shutter (GS) cameras, which expose all pixels simultaneously, mitigate RS artifacts. The disclosure provided herein leverages GS technology to enable precisely controlled lens distortions that increase effective pixel density in one or more ROIs, yielding higher system accuracy while ensuring stable and reliable distortion compensation.

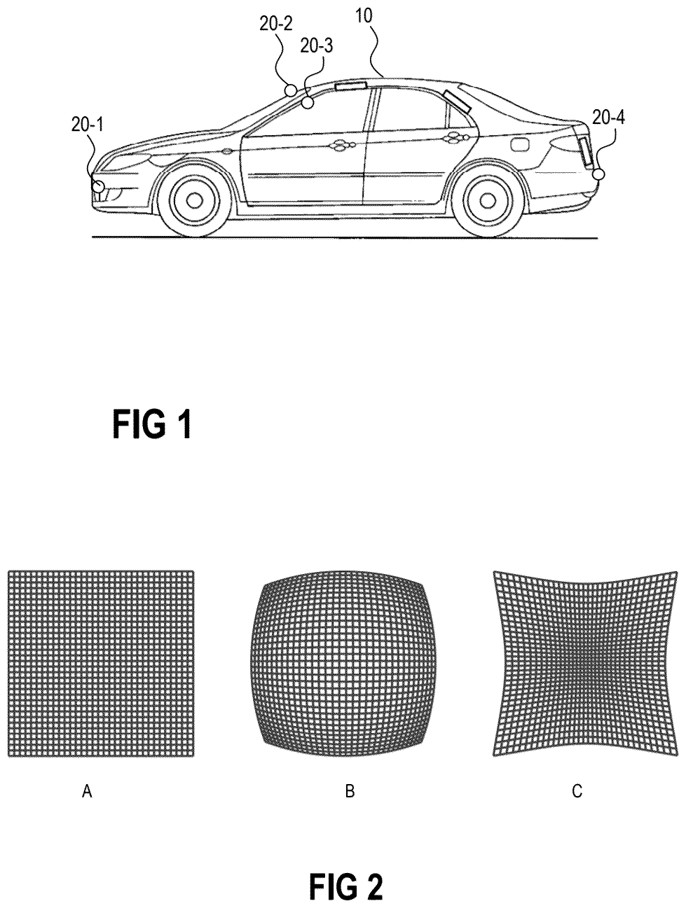

Referring to FIG. 1, a vehicle 10 with a plurality of cameras 20-1, 20-2, 20-3, 20-4 mounted thereto is schematically illustrated. In the example illustrated in FIG. 1, cameras 20-1, 20-2 and 20-4 are outward facing cameras, while camera 20-3 is an inward facing camera. Different cameras 20-N may be arranged in any suitable position with regard to the vehicle 10 in order to be able to capture images that are required to implement certain driver assistance systems. A driver assistance system generally may include one or more inward facing cameras and/or one or more outward facing cameras. The number and orientation of the cameras depends on the purpose of the driver assistance system. In one embodiment of the present disclosure, the plurality of cameras may be GS cameras.

Cameras 20-N may include on or more optical lenses. Optical lenses may cause the images that are captured by the respective camera 20-N to be distorted. An image is considered to be distorted when the straight lines of an image appear to be deformed or curved unnaturally. An example of an image without distortion is schematically illustrated in FIG. 2A. FIG. 2 further illustrates two further common types of radial distortion, namely barrel distortion B and pincushion distortion C. When barrel distortion occurs, image magnification decreases with distance from the optical axis. The apparent effect is that of an image which has been mapped around a sphere (or barrel). When pincushion distortion occurs, image magnification increases with the distance from the optical axis. The visible effect is that lines that do not go through the center of the image are bowed inwards, towards the center of the image, like a pincushion. Mathematically, barrel and pincushion distortion are quadratic, meaning they increase as the square of distance from the center. Other distortions are generally possible, but do not generally occur in conventional lenses. Different kinds of distortion occur, depending on the kind of lens system that is used for a camera and depending on whether the lens can or cannot be removed from the camera.

Distortion commonly occurs from aberrations near the edges of the image. Each type of distortion usually develops through different variables. Barrel distortion, for example, is often the result of a lens at full zoom or a lens in wide angle settings, while pincushion distortion occurs most often when telephoto lenses are used. Fisheye lenses, for example, which take hemispherical views, utilize barrel distortion as a way to map an infinitely wide object plane into a finite image area. In a zoom lens, barrel distortion occurs in the middle of the lens's focal length range and is worst at the wide-angle end of the range. Concave (minus) spherical lenses also tend to result in barrel distortion. Convex (plus) spherical lenses tend to result in pincushion distortion. Certain lenses may exhibit barrel distortion, pincushion distortion, or no distortion depending on zoom settings.

As can be seen from the above, distortion is usually associated with zoom lenses, in particular large-range zooms, but may also be found in prime lenses and depends on focal distance. Distortion is generally considered as an artifact that is to be corrected. However, the type of lens curvature and the resulting distortion configuration may be engineered to bias more pixels towards one or more regions of the image FOV.

Thus, the driver assistance systems described in the following, however, utilize (take advantage of) this artifact. As can be seen in FIG. 2 B, if barrel distortion occurs, pixel density is lower in the center of the image as compared to the edges and especially the corners. If pincushion distortion occurs (FIG. 2 C), pixel density is higher in the center of the image as compared to the edges and especially the corners of the image. For regions of an image with higher pixel density, more information is generally available as compared to regions of the image with lower pixel density.

GS cameras, as described herein, may capture the distorted image without introducing RS-related motion artifacts and thus allow for distortion compensation without motion correction. In GS cameras, all pixels of the camera array are exposed simultaneously, ensuring that the entire image FOV represents the same moment in time. This temporal correlation allows for performing distortion compensation on images where the ROI contains moving objects. For example, distortion compensation as herein described in the context of GS image acquisition may be useful for driver or occupant monitoring applications where facial features, eye movements, or head position changes are being tracked as well as outward-facing obstacle detection where pedestrians, vehicles, or other moving objects are present in the vehicle's surroundings.

Thus, image enhancement may compensate for the distortion while maintaining the higher density pixel regions. With GS, the entire frame is exposed simultaneously, meaning that distortion is captured spatially but not temporally (e.g., without temporal skew). This allows for a deterministic distortion map to be generated that can be modeled and corrected. In GS camera scenarios, distortion compensation may comprise calibrating the camera and lens to measure how optics bend in the image, for example particular to the type of distortion (e.g., pincushion, barrel, etc.). Thus, when processing each frame, an undistorted grid of pixels can be generated. For every pixel in the outputted grid, a corresponding location in the distorted input image may be determined. Once the source locations are determined (e.g., and stored in a look-up-table), the image may be resampled, for example with a bilinear interpolation algorithm, to fill in the undistorted (e.g., output) image. Because GS avoids temporal skew, calibration of distortion patterns need only be done once and then stored as a static look-up table. Because GS cameras expose all pixels at the same moment, distortion compensation applies uniformly across the entire image, thereby allowing for maintenance of the high pixel density regions which increases the image quality and resolution in those regions.

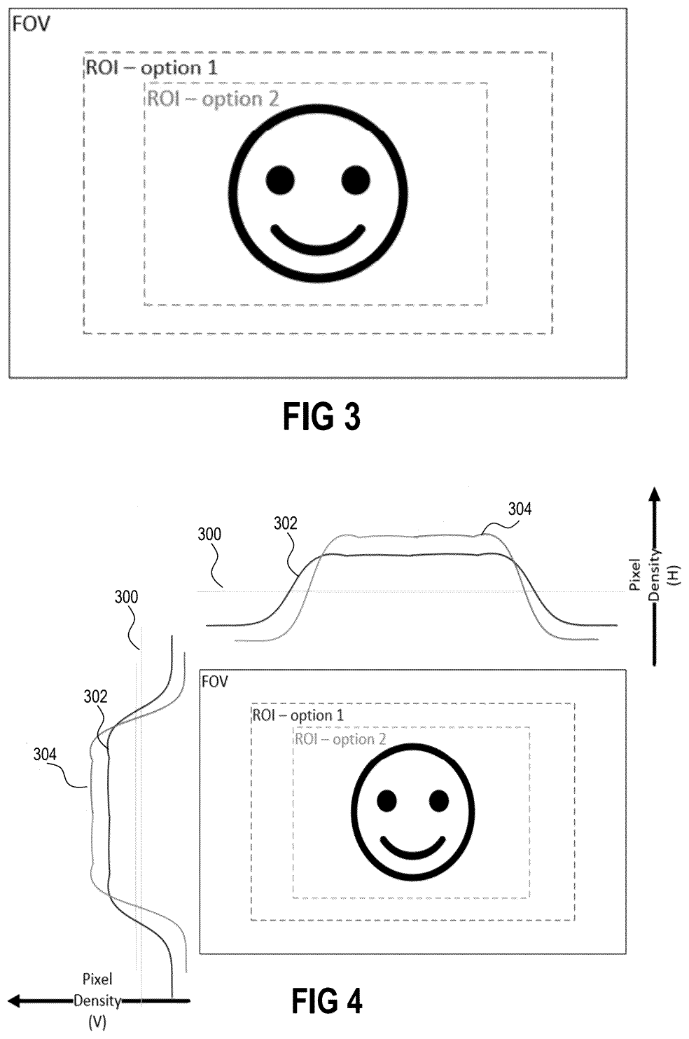

Now referring to FIG. 3, a field of view FOV of a camera of a driver assistance system is schematically illustrated. The camera may be an inward facing camera of a vehicle that captures one or more images inside of the vehicle. In this way, the camera may capture a driver or passenger of the vehicle, for example. Such systems are often also referred to as driver monitoring systems DMS, or occupant monitoring systems OMS. It is however also possible that the camera is an outward facing camera that captures one or more images outside of the vehicle. In this way, the camera may capture pedestrians or obstacles in the surroundings of the vehicle. The camera may be rotatable such that it can capture one or more images of the inside and/or the outside of the vehicle, depending on its orientation. In most cases, only certain sections or details of an image captured with a camera of a driver assistance system are of particular relevance, e.g., the section in which the face of the driver or passenger, or in which a pedestrian or obstacle in the surroundings of the vehicle can be found. Therefore, the region of interest ROI within an image captured by a camera of a driver assistance system is generally smaller than the field of view FOV of the camera (the entire area of the image). The region of interest ROI may have any suitable size. FIG. 3 schematically illustrates a larger region of interest ROI according to a first example (option 1), and a smaller region of interest ROI according to a second example (option 2). The size of the region of interest ROI may depend on the size of the object of interest that is captured within the field of view FOV. For example, the region of interest ROI is usually larger if an object of interest captured on the image is located close to the camera, and the region of interest may be comparably small if the same object of interest or another object of interest having a similar size is located further away from the camera.

According to one embodiment of the present disclosure, a driver assistance system includes a camera that is configured to capture one or more images having a defined field of view FOV. The camera includes an optical lens that causes distortion of the one or more captured images. If, for example, a region of interest ROI is located at the center of the captured images, a camera with a lens causing pincushion distortion may be used. In this way, pixel density in the region of interest ROI is increased as compared to other, irrelevant or less relevant, regions of the image. The pixel density depending on a position within the captured image (field of view FOV) adapted to different regions of interest ROI is schematically illustrated in FIG. 4, wherein a region of interest ROI according to a first option is larger than a region of interest ROI according to a second option. For the larger region of interest ROI (option 1) the pixel density is low in regions within the field of view FOV that lie outside of the region of interest ROI and essentially has a first value over a greater part of the region of interest ROI. For the smaller region of interest ROI (option 2) the areas of low pixel density in areas outside the region of interest are larger as compared to option 1. The pixel density essentially has a second value that is larger than the first value over a greater part of the region of interest ROI. The area of increased pixel density (first/second value) is larger for the larger region of interest ROI, and smaller for the smaller region of interest ROI.

The size of the area of increased pixel density may depend on the kind of camera or lens that is used to capture the picture and on the magnitude of the zoom of a zoom lens, for example. For a camera including a lens that does not cause any distortion, pixel density is essentially equal for all positions within the captured image (line 300). With a lens causing moderate pincushion distortion (e.g., zoom lens at partial zoom), pixel density is increased for large parts of the image. A lower pixel density in this case usually only exists close to the edges of the image (line 302). With a lens causing strong pincushion distortion (e.g., zoom lens at full zoom), pixel density is highly increased at the center of the image, and decreases more rapidly towards the edges of the image (line 304). If the position of the region of interest ROI corresponds to the region of the image having the highest pixel density, more information will be available for the region of interest ROI than for any irrelevant or less relevant regions of the image lying within the field of view FOV but outside of the region of interest ROI.

Radial distortion in an image can be corrected by means of image processing. Standard approaches include, for example, approximating, locally linearizing, and iterative solvers. Generally speaking, the distortion can be corrected by means of any suitable image signal processing method, e.g., utilizing common optical distortion compensation blocks. Different methods for distortion compensation are generally known and will not be described in detail herein. The resulting corrected image, however, due to the original distortion, still includes an increased detail level within the region of interest ROI. When presenting the corrected image to the user or when further processing the corrected image, more information (image data) is available for the region of interest ROI than for other regions within the field of view FOV.

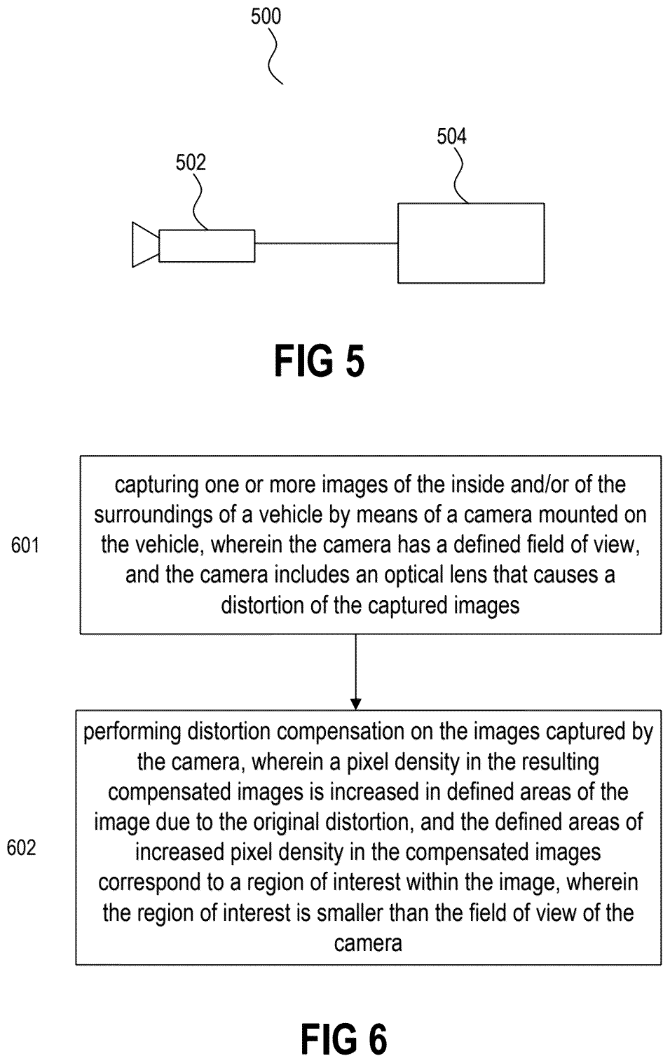

Now referring to FIG. 5, a driver assistance system 500 according to one embodiment of the present disclosure is schematically illustrated. The driver assistance system 500 includes a camera 502 configured to capture one or more images. The camera 502 includes an optical lens, wherein the optical lens causes one or more images captured with the camera 502 to be distorted. The driver assistance system 500 further includes a processing unit 504. The distorted images captured by the camera 502 are provided to the processing unit 504. The processing unit 504 is configured to perform distortion compensation on the captured images. The resulting compensated images may then be further processed. Further processing may occur in the processing unit 504 or in a separate processing unit (not specifically illustrated). Further processing may include identifying potentially dangerous situations, and generating an alert that may be perceived by a driver and/or occupant of the vehicle if a potentially dangerous situation has been identified.

A situation may be considered potentially dangerous if an increased likelihood of collision with a detected object or obstacle is detected, or if an increased drowsiness level or decreased driver attention level is detected, for example. Many other potentially dangerous situations generally may be detected.

The camera 502 may be arranged on a vehicle such that a region of interest ROI within the field of view FOV of the camera 502 corresponds to a region of increased pixel density of the captured images, the pixel density depending on the distortion caused by the optical lens.

An inward facing camera may be static, for example. The camera may be oriented towards a driver's seat or a passenger seat of the vehicle. Although different persons may have different sizes, a person's head will most likely be arranged within the center of the image when the person is seated in the respective seat. The region of interest ROI (the person's head or face), therefore corresponds or at least overlaps to a large amount with the region of increased pixel density at the center of the image, if an optical lens causing pincushion distortion is used. It is, however, also possible that the camera is movable such that the region of increased pixel density can be aligned with the region of interest ROI when the head of an occupant of the vehicle is recognized, e.g., by facial recognition techniques.

Outward facing cameras may also be static or movable. Pedestrians or other obstacles may not always be detected in the same area of the images captured with the camera. Therefore, if a static camera with an optical lens causing pincushion distortion (area of increased pixel density in the center of the field of view FOV) is used, for example, it may happen that an obstacle is detected within the field of view FOV, but outside of the area of increased pixel density. Therefore, a movable camera may be used, for example. Once an obstacle is detected, the orientation of the camera may be adjusted such that the region of increased pixel density is aligned with the region of interest ROI in which the obstacle was detected. However, this may not be necessarily required. Outward facing cameras may also be static. If an outward facing camera is arranged to monitor the road in front of or behind the vehicle, it may be assumed that no objects of interest are captured within the upper third of the image. Objects that are located next to the road, but not on the road, towards the sides of the image may also be of lower interest. The region of higher pixel density, therefore, may be arranged in those parts of the image (lower two thirds, center) where objects of interest are more likely to be detected.

As a non-limiting example, a first region of a captured image may be a region with higher pixel density and a second region of the captured image may be a region with an anticipated higher interest (e.g., the lower two thirds of the FOV or the center of the FOV, etc.). The first region may at least partially overlap with the second region to form a sub-region. In some examples, the first and second regions may only partially (e.g., not full) overlap such that the sub-region comprises a first portion of the first region but not a second portion of the first region and a first portion of the second region but not a second portion of the second region. Compensated images may retain the first region, the second region, and the sub-region. When the orientation of the camera is alterable, the sub-region may be aligned with an ROI by altering the orientation of the camera. For example, the sub-region may be aligned with a detected object or obstacle by altering the orientation of the camera. Thus, when distortion compensation is performed, resulting compensated images may comprise the sub-region that corresponds to the ROI with higher pixel density.

Now referring to FIG. 6, a method according to one embodiment of the present disclosure is schematically illustrated in a flow diagram. The method includes capturing one or more images inside and/or outside of a vehicle by means of a camera mounted on the vehicle (step 601), wherein the camera has a defined field of view, and the camera includes an optical lens that causes a distortion of the captured images, and performing distortion compensation on the images captured by the camera by means of a processing unit (step 602), wherein a pixel density in the resulting compensated images is increased in defined areas of the image due to the distortion, and the defined areas of increased pixel density in the compensated images correspond to a region of interest within the image, wherein the region of interest is smaller than the field of view of the camera.

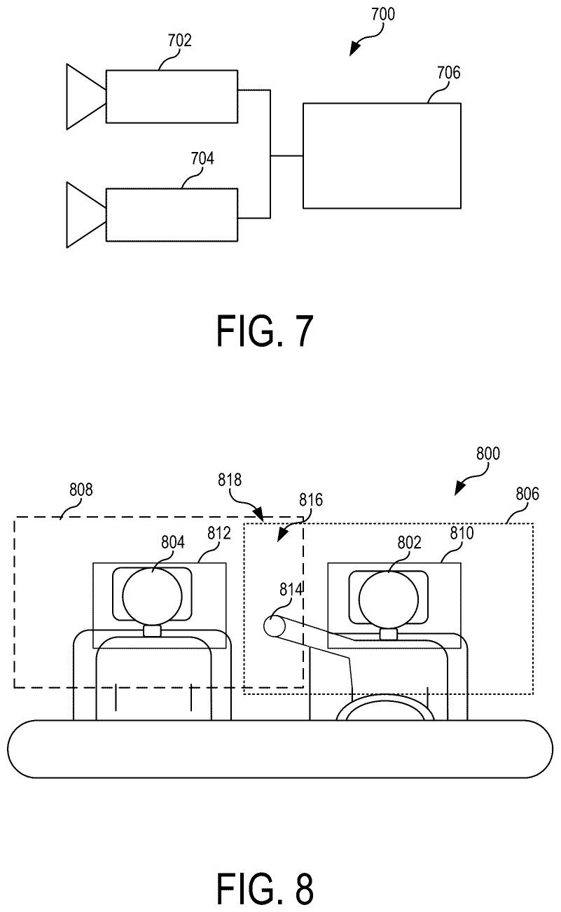

Now referring to FIG. 7, a driver assistance system 700 is shown. The driver assistance system 700 may be an example of an ADAS that incorporates OMS whereby both the driver and the passenger (and if present, rear seat passengers) are monitored. The driver assistance system 700 comprises a first camera 702 and a second camera 704. It should be understood that in some examples the driver assistance system 700 may comprise additional cameras.

Each of the first and second cameras 702, 704 may be configured to capture one or more images, for example of the interior cabin of a vehicle (e.g., of one or more occupants) or of the exterior environment. Each of the first and second cameras 702, 704 includes an optical lens, wherein the optical lens causes one or more images captured with the first and second cameras 702, 704 to be distorted. The driver assistance system 700 further includes a processing unit 706. The distorted images captured by the first and second cameras 702, 704 are provided to the processing unit 706. The processing unit 706 is configured to perform distortion compensation on the captured images. The resulting compensated images may then be further processed. Further processing may occur in the processing unit 706 or in a separate processing unit (not specifically illustrated). Further processing may include identifying potentially dangerous situations, and generating an alert that may be perceived by a driver and/or occupant of the vehicle if a potentially dangerous situation has been identified.

An example scenario 800 for the driver assistance system 700 is illustrated in FIG. 8. In the example scenario 800, a first occupant 802 is seated in a driver seat and a second occupant 804 is seated in a front passenger seat. A first camera (e.g., first camera 702) may be positioned to capture a first image 806 of the first occupant 802 and a second camera (e.g., second camera 704) may be positioned to capture a second image 808 of the second occupant 804.

In OMS, each seat or interaction zone can serve as an ROI. In the example scenario 800, the first image 806 comprises a first ROI 810 that is centered around the face of the first occupant 802, such as is the case when the higher pixel density resides in the center of the image (e.g., in pincushion distortion). Similarly, a second ROI 812 that is centered around the face of the second occupant 804 may be present when pincushion distortion is exhibited by the second camera.

However, as illustrated, in certain scenarios, neither camera of a multi-camera system may include an object of interest within the respective higher pixel density regions. For example, the first occupant 802 may be performing one or more hand gestures 814 at a region of the first image 806 that is not included in the first ROI 810. For example, the hand gestures 814 may be aimed at controlling operation of a head unit (e.g., turning up the volume, changing an outputted media, etc.) and thus may be toward an outer edge 816 of the first image 806 that is centered on the face of the first occupant 802. The position of the hand gestures 814 may also be in an outer, low pixel density region of the second image 808. In the example shown in FIG. 8 the outer edge 816 of the first image 806 is at a middle of the vehicle and overlaps with an outer edge of the second image 808 in overlapping region 818.

In some examples, the first image 806 and the second image 808 may be vertically offset such that in the overlapping region 818 the first image 806 samples different pixels of the overlapping region 818 than the second image 808. This may allow for the pixels of the first image 806 corresponding to the overlapping region 818 to be combined with the pixels of the second image 808 corresponding to the overlapping region 818, as described below. This may increase the pixel density for the overlapping region even with the distortion. Thus, three regions of relatively high pixel density may be defined, two corresponding to the regions of increased pixel density from the cameras' lens distortion and a third in the FOV overlapping region.

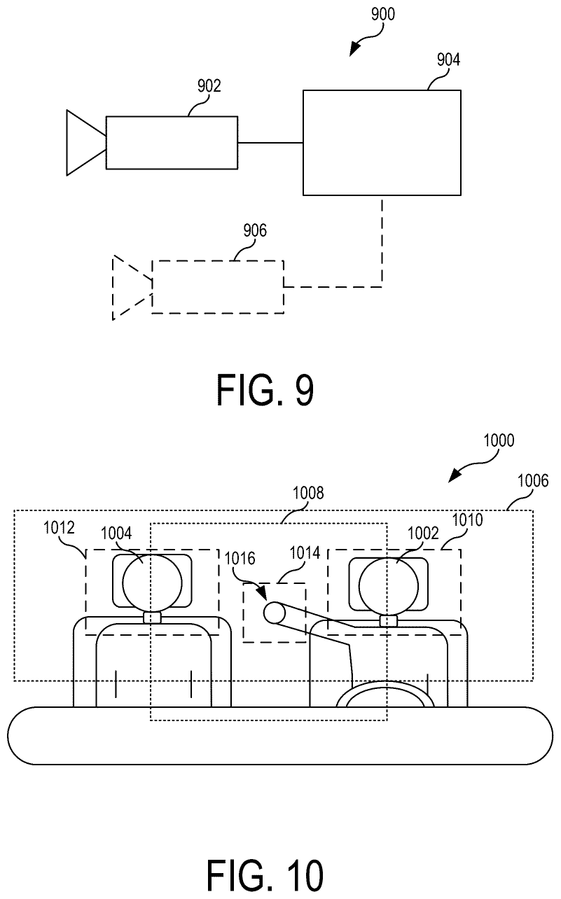

FIG. 9 illustrates a third example driver assistance system 900 that includes a compound lens camera 902. The compound lens camera may be utilized in a multi-ROI scenario. For example, both a face and a hand of a driver may be considered ROIs, the face for detecting facial expressions, eye gaze, and the like as herein described, and the hand for detecting hand gestures. As another example, the compound lens camera may be positioned to capture images of both the driver and front passenger of a vehicle. The face of the driver may be a first ROI and the face of the passenger may be a second ROI. Similar to the other driver assistance systems herein described, the driver assistance system 900 may comprise a processing unit 904. The distorted images captured by the compound lens camera 902 are provided to the processing unit 904. The processing unit 904 is configured to perform distortion compensation on the captured images. The resulting compensated images may then be further processed. Further processing may occur in the processing unit 904 or in a separate processing unit (not specifically illustrated). Further processing may include identifying potentially dangerous situations, and generating an alert that may be perceived by a driver and/or occupant of the vehicle if a potentially dangerous situation has been identified.

In some examples, the driver assistance system 900 comprises an additional second camera 906. The second camera 906 also comprises a lens that causes distortion in captured images. In some examples, the second camera 906 may be activated in response to one or more conditions, such as an object of interest being detected in a low pixel density region of an image acquired by the compound lens camera 902, as further described below.

FIG. 10 shows an example scenario 1000 of the driver assistance system 900 that includes a compound lens camera. In the example scenario 1000, a first occupant 1002 is seated in a driver seat and a second occupant 1004 is seated in a front passenger seat. A compound lens camera (e.g., compound lens camera 902) may be positioned to acquire images 1006 of the first and second occupants 1002, 1004. The compound lens camera may be configured with multiple regions of increased pixel density. For example, the compound lens camera may be configured to define two regions of pincushion distortion or two regions of barrel distortion. Pincushion distortion is herein described for illustrative purposes.

A first ROI 1010 may be defined corresponding to a first region of increased pixel density and a second ROI 1012 may be defined corresponding to a second region of increased pixel density. The first ROI 1010 may align with the face of the first occupant 1002 and the second ROI 1012 may align with the face of the second occupant 1004. Thus, compound lens distortion may increase pixel density in multiple ROIs while background is compressed.

In some examples, an object of interest 1016 may be detected in a lower pixel density region of the image 1006 (e.g., outside of the first ROI 1010 and second ROI 1012). As an example, the first and second ROIs 1010, 1012 may center around faces of the first and second occupants 1002, 1004. An occupant may perform one or more hand gestures, for example to control the vehicle head unit, in regions of the compound lens camera's FOV that correspond to lower pixel density. In such an example, a second camera may be activated to acquire second image(s) 1008. The second camera may also have a lens that causes distortion such that a third ROI 1014 of the second image 1008 corresponds to a region of increased pixel density compared to other regions of the second image 1008. The third ROI 1014 may contain the object of interest 1016 that was detected within the image 1006. In some examples, the second camera may have an adjustable orientation such that the region of increased pixel density based on the distortion type can be aligned with the third ROI 1014. In this way, three regions of increased pixel density may be defined in distortion compensated images. As illustrated, the second camera's FOV may at least partially overlap with the FOV of the first camera such that the second camera can capture information of the object of interest detected within the image captured by the first camera.

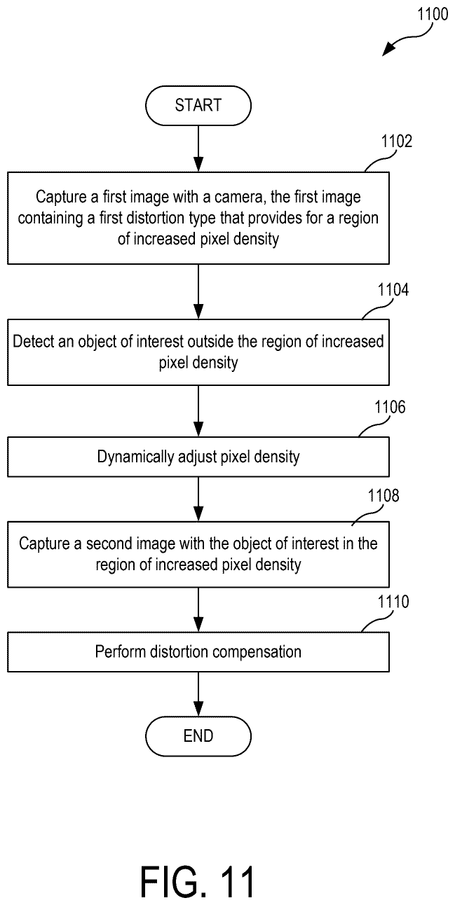

In an example when an object of interest resides outside a region of increased pixel density, dynamic ROI adjustment may be performed to increase pixel density in a low pixel density region. FIG. 11 shows a flowchart illustrating a method 1000 for dynamic ROI adaption in a driver assistance system, such as the driver assistance system 500 or the driver assistance 700 described herein above. The method 1100 may be executable by a processing unit of the driver assistance system (e.g., processing unit 504, processing unit 706, processing unit 904) according to instructions stored in non-transitory memory.

At 1102, method 1100 comprises capturing a first image with a camera, wherein the first image contains a first distortion type that provides for a region of increased pixel density in a first position within the first image. Thus, the camera FOV may have a first region with a high pixel density and a second region with a lower pixel density.

The camera may be an inner facing camera or external facing camera. As described herein, the camera may be GS cameras that comprises an optical lens causing distortion in captured images. In the example described herein, the first distortion type may be a pincushion distortion wherein the pixel density is higher in the center of the first captured image. Thus the first position of increased pixel density may be in the center of the first image. In some examples, pincushion distortion may be a default amount of distortion when the center of the first image contains an ROI such as an occupants face (e.g., for inward facing cameras) or a road (e.g., for external facing cameras).

At 1104, method 1100 includes detecting an object of interest outside the region of increased pixel density. As an example, the cameras may be an inward facing camera configured to acquire images of a driver of the vehicle. In such an example, the first distortion type may be a pincushion distortion wherein the region of increased pixel density is positioned in the center of the image, so as to be located around the driver's face. Regions outside the center of the image, such as the outer edges of the image, may have a lower pixel density.

At 1106, method 1100 includes dynamically adjusting the pixel density of the camera. Dynamically adjusting the pixel density may comprise reallocating pixel budget across the cameras FOV to effectively change the distortion type/configuration. For example, the camera may be switched from the first distortion type to a second distortion type. As an example, the camera may comprise an optical lens that exhibits pincushion distortion in a first setting (e.g., telephoto) and barrel distortion in a second setting (e.g., wide-angle). Switching from pincushion to barrel distortion may decrease pixel density in the center of captured images and increase pixel density at the outer edges of captured images. Thus, the position of the region of increased pixel density may be moved such that the object of interest may reside in the region of increased pixel density when the camera(s) are set to the second distortion type. In some examples, dynamic adjustment of pixel density may apply only to the camera that captured the image that includes the object of interest (e.g., the corresponding camera). Other cameras of the vehicle may be unchanged such that they continue to acquire images per current settings.

At 1108, method 1100 includes capturing a second image with the camera with the object of interest in the region of increased pixel density, which may be in the second adjusted position within the camera FOV. For example, when the second distortion type is barrel distortion, the region of increased pixel density may correspond to the outer edges of the camera's FOV. The image may thus include information of the object of interest within the region of increased pixel density.

At 1110, method 1100 includes performing distortion compensation. When dynamic ROI adjustment is performed, distortion compensation may be performed on the one or more second images. When pixel combination is performed, distortion compensation may be performed on the one or more first images and the combined image of the overlapping region.

While the method 1100 is herein described as the object of interest being detected in the captured images prior to distortion compensation, it should be understood that in some examples the object of interest may be detected within compensated images alternatively.

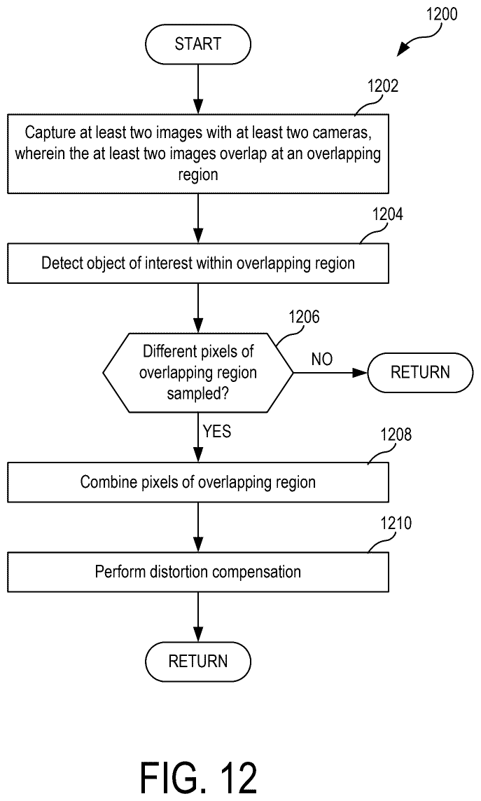

FIG. 12 shows a flowchart illustrating a method 1200 for a driver assistance system. Method 1200 is herein described with respect to the driver assistance system 700 of FIG. 7, though it should be understood that the method 1200 may be applicable to other systems. The method 1200 may be executed by a processing unit (e.g., processing unit 706) according to instructions stored in non-transitory memory.

At 1202, method 1200 includes acquiring at least two images with at least two cameras, wherein the at least two images at least partially overlap at an overlapping region. As an example, a first camera may acquire a first image and a second camera may acquire a second image. Both the first and second cameras may include a lens that causes distortion, such as pincushion or barrel distortion. For example, the first image may include a first region of increased pixel density and a second region of lower pixel density and the second image may include a first region of increased pixel density and a second region of lower pixel density. In one example, the regions of increased pixel density may be aligned with respective ROIs, such as occupant faces. The overlapping region may correspond to the lower pixel density regions of the first and second images.

At 1204, method 1200 includes detecting an object of interest within the overlapping region. As an example, the first and second images may overlap in the middle of the vehicle (e.g., near the midline). As the overlapping region corresponds to the lower pixel density regions of the respective images, the object of interest may thus reside in a lower pixel density region of either the first or second image individually.

At 1206, method 1200 determines of the first and second images sample different pixels of the overlapping region. For example, the camera FOV of the first camera may be offset, for example vertically, from the FOV of the second camera such that the pixels of the overlapped region captured in the first image different from the pixels of the overlapped region captured in the second image. If the first and second images sample different pixels of the overlapped region, method 1200 proceeds to 1208. If the two cameras sample the same pixels, method 1200 can optionally feed into method 1100, for example at 1106 to dynamically adjust the regions of pixel intensity as described above.

At 1208, method 1200 includes combining the pixels in the overlapping region. For example, pixels in the overlapping region belonging to a first image captured by the first camera may be fused with pixels in the overlapping region belonging to the second image captured by the second camera. Fusion may use geometric alignment (e.g., calibration with depth and flow) to combine the pixels from the first and second images into a single set of non-uniform subpixel samples. These non-uniform subpixel samples may then be reconstructed into a new version of the overlapping region that has a higher pixel density than provided by either the first or second image alone.

It should be understood however that in some examples, even when more than one image of the object of interest is acquired with different sampled pixels, the method 1200 may perform dynamic adjustment of pixel intensity rather than pixel combination. For example, when the object of interest is a moving object like a hand gesture, multiple combinations of pixels may be demanded to capture high-pixel density images of the object of interest. This may be computationally demanding and the system may alternatively dynamically adjust the distortion type instead for a period of time to increase pixel density in the overlapped region to reduce computational demands. In such an example, one of the cameras that imaged the object of interest may be selected and pixel density may be changed for that camera but not the other camera(s). Alternatively, the ROI captured with the one or more cameras providing the first distortion type may still be demanded by the driver assistance system. In such a case, the method may perform pixel combination for the object of interest rather than dynamically adjusting the distortion configuration so as allow the cameras to continue to capture images with the higher pixel density in the first ROI position.

At 1210, method 1200 includes performing distortion compensation. Distortion compensation may be performed wherein the regions of increased pixel density within the first and second images are retained in the compensated images and wherein, in the overlapping region, the increased pixel density resulting from pixel combination is retained in both images. For example, the pixels of the overlapping region that are combined may replace the original, low density pixels of both the first and second images.

While the method 1200 is herein described as the object of interest being detected in the captured images prior to distortion compensation, it should be understood that in some examples the object of interest may be detected within compensated images alternatively.

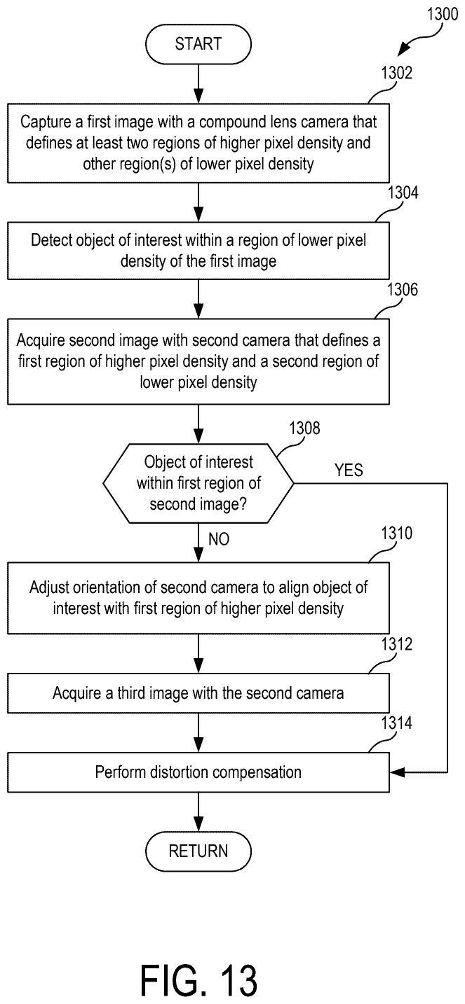

Turning now to FIG. 13, a flowchart illustrating a method 1300 for a driver assistance system is shown. The driver assistance system may be the driver assistance system 900 described above with respect to FIGS. 9 and 10. The method 1300 may be executed by a processing unit (e.g., processing unit 904) according to instructions stored in non-transitory memory.

At 1302, method 1300 includes capturing an image with a compound lens camera. As described above, the compound lens camera may comprise an optical lens that causes distortion that provides for more than one region of relatively higher pixel density. As an example, a double pincushion distortion may be caused by the compound lens, wherein a first pincushion results in a first region of increased pixel density and a second pincushion results in a second region of increased pixel density. Other region(s) of the image captured with the compound lens camera may have lower pixel density (e.g., may be compressed).

At 1304, method 1300 includes detecting an object of interest within a lower pixel density region. As an example, the compound lens camera may be an inward facing camera configured to capture images of the driver and front passenger of a vehicle. The first and second regions of increased pixel density may be aligned with the faces of the driver and front passenger. An object of interest may be detected between the driver and front passenger, such as a hand of the driver or front passenger performing hand gestures to control a vehicle head unit. As another example, the compound lens camera may be external facing configured to capture images of a front driver side of the vehicle. The two regions of higher pixel density may be configured based on likelihood of obstacles (e.g., forward towards the road and lateral to face an adjacent lane). An object of interest may be detected in a lower pixel density region between the two regions of higher pixel density.

At 1306, method 1300 includes capturing a second image with a second camera. The second camera may comprise a lens that causes distortion as well. The distortion may result in a first region of higher pixel density and a second region of lower pixel density, relatively. For example, the second camera may comprise an optical lens configured to provide pincushion distortion (e.g., with a single pincushion region).

At 1308, method 1300 determines if the object of interest was captured in the higher pixel density region of the second image. If so, method 1300 proceeds to 1316. If not, method 1300 proceeds to 1310.

At 1310, method 1300 includes adjusting an orientation of the second camera to align the region of higher pixel density with the object of interest. For example, the second camera may be an adjustable camera wherein an orientation of the camera may be adjusted to change the position of the camera's FOV. When the camera's FOV is repositioned, the position of the region of higher pixel density may change relative to the object of interest.

At 1312, method 1300 includes acquiring a third image with the second camera. The third image may be acquired with the second camera in the new position wherein the region of higher pixel density is aligned with the object of interest.

At 1314, method 1300 includes performing distortion compensation. As described herein, distortion compensation may be performed to remove the appearance of the warp in the image while retaining the pixel densities. For the compound lens image (e.g., the first image), distortion compensation may comprise calibrating distortion patterns once, storing the patterns as a static distortion compound look-up table, thus ensuring that pixel distribution is predictable and stable. Thus, the first region of increased pixel density and the second region of increased pixel density from the compound lens camera image may be retained and the region of increased pixel density in the second or third image acquired by the second camera (depending on whether the second camera orientation was changed) is retained. Thus, three regions of increased pixel density may be retained, allowing for high quality image capture of multiple regions. In this way, multiple ROIs may be captured with relatively high pixel density, allowing for increased image quality, more accurate detection of eye movements, hand gestures, etc., and more accurate detection of dangerous obstacles.

The second camera may thus only be activated to capture images when an object of interest is detected in a lower pixel density region of images captured by the compound lens camera. This may reduce bandwidth and processing demands on the driver assistance system as images from the second camera need only be processed in certain circumstances when at baseline the second camera is dormant.

While the method 1300 is herein described as the object of interest being detected in the captured images prior to distortion compensation, it should be understood that in some examples the object of interest may be detected within compensated images alternatively.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should not be understood as excluding the plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly disclose subject matter from the above description that is regarded to be novel and non-obvious.

1. A driver assistance system for a vehicle, the driver assistance system comprising:
a processing unit; and
a camera mounted on the vehicle and configured to capture one or more images inside and/or outside of the vehicle, the camera having a defined field of view (FOV) and comprising an optical lens configured to cause a distortion of the one or more images, wherein:
in response to the distortion of the one or more images, at least one of the one or more images comprises a first region that has a relatively higher pixel density than other areas of the at least one of the one or more images and a second region, wherein the first region partially, but not fully, overlaps with the second region to form a sub-region;
the processing unit is configured to perform distortion compensation of the one or more images to obtain one or more compensated images, wherein the one or more compensated images retain the first region, the second region, and the sub-region; and
the processing unit is configured to determine a region of interest (ROI) within the FOV of the camera, the ROI being smaller than the FOV of the camera and the processing unit being configured to align the sub-region with the ROI by altering an orientation of the camera such that the sub-region in the one or more compensated images corresponds to the ROI within the one or more compensated images.

2. The driver assistance system of claim 1, wherein the camera is a global shutter (GS) camera and wherein distortion compensation is performed in the context of GS.

3. The driver assistance system of claim 1, wherein the optical lens causes one or more of a pincushion distortion and barrel distortion.

4. The driver assistance system of claim 3, wherein the optical lens comprises a telephoto lens when the optical lens causes the pincushion distortion.

5. The driver assistance system of claim 1, wherein the driver assistance system is further configured to present the one or more compensated images on a display of the vehicle.

6. The driver assistance system of claim 1, wherein the processing unit is further configured to further process the one or more compensated images.

7. The driver assistance system of claim 6, wherein further processing the one or more compensated images comprises identifying potentially dangerous situations, and generating an alert that may be perceived by a driver and/or an occupant of the vehicle if a potentially dangerous situation has been identified.

8. The driver assistance system of claim 7, wherein the processing unit is configured to identify objects or obstacles in the surroundings of the vehicle, and to determine a probability of collision of the vehicle and the identified objects or obstacles, wherein a potentially dangerous situation is identified if a probability of collision exceeds a defined threshold.

9. The driver assistance system of claim 7, wherein further processing the one or more compensated images comprises determining one or more driver or occupant parameters, and determining a drowsiness level and/or an attention level of the driver or occupant of the vehicle based on the driver or occupant parameters, wherein a potentially dangerous situation is identified if the drowsiness level exceeds a defined threshold and/or if the attention level falls below a defined threshold.

10. The driver assistance system of claim 1, wherein the camera is a movable camera, and the processing unit is configured to determine the ROI within FOV of the camera, and to align the region of increased pixel density with the ROI by changing an orientation of the camera.

11. The driver assistance system of claim 1, wherein the processing unit is further configured to:
in response to detecting an object of interest within one of the other areas of the at least one of the one or more images that have relatively lower pixel density, change a type of distortion of the camera from the distortion to a second distortion;
capture one or more second images with the camera wherein the optical lens causes the second distortion, wherein in the one or more second images, the object of interest is within the a region of relatively higher density within the one or more second images, wherein the FOV of the camera is unchanged; and
perform distortion compensation on the one or more second images.

12. The driver assistance system of claim 1, further comprising a second camera mounted on the vehicle and configured to capture one or more second images inside and/or outside of the vehicle, the camera having a defined second FOV and comprising a second optical lens configured to cause a second distortion of the one or more second images, wherein the second FOV at least partially overlaps with the FOV of the camera at an overlapping region, wherein the processing unit is configured to:
detect an object of interest within the overlapping region; and
combine first pixels of the overlapping region from the one or more images with second pixels of the overlapping region from the one or more second images.

13. The driver assistance system of claim 1, wherein the camera is a compound lens camera, wherein the optical lens defines more than one region of relatively higher pixel density within the FOV of the camera, wherein each of the more than one region of relatively higher pixel density corresponds to a different ROI.

14. A method comprising
capturing one or more images inside and/or outside of a vehicle by means of a camera mounted on the vehicle, wherein the camera has a defined field of view (FOV), and the camera comprising an optical lens that causes distortion of the captured images, wherein the camera is a global shutter (GS) camera configured to expose all pixels of the FOV simultaneously,
performing distortion compensation on the one or more images captured by the camera by means of a processing unit, wherein distortion compensation comprises calibrating distortion patterns once and storing the calibrated distortion patterns as a static distortion look-up table, wherein:
a pixel density in the resulting one or more compensated images is increased in one or more defined areas of the image due to the distortion; and
the one or more defined areas of pixel density in the one or more compensated images correspond to a region of interest (ROI) within the image, wherein the ROI is smaller than the FOV of the camera.

15. The method of claim 14, further comprising:
detecting an object of interest outside of the one or more defined areas;
altering a pattern of the distortion caused by the optical lens;
capturing one or more second images with the camera with the optical lens causing the altered pattern of the distortion; and
performing distortion compensation on the one or more second images, wherein pixel density in the one or more second compensated images is increased in one or more different areas compared to the one or more areas of the image and the one or more different areas correspond to the object of interest.

16. The method of claim 14, further comprising:
capturing one more second images by a second camera comprising an optical lens that causes distortion, wherein a second FOV of the second camera at least partially overlaps with the FOV of the camera at an overlapping region, wherein due to the distortion of the camera and the second camera, the overlapping region has relatively lower pixel density in the captured one or more images and one or more second images;
detecting an object of interest within the overlapping region;
combining pixels of the one or more images from the overlapping region with pixels of the one or more second images from the overlapping region.

17. The method of claim 14, wherein the camera is a compound lens camera wherein the optical lens causes distortion that includes more than one region of increased pixel density, the method further comprising:
detecting an object of interest within the one or more images outside of the more than one region of increased pixel density;
acquiring a second image with a second camera, the second camera comprising an optical lens that causes distortion resulting in a region of increased pixel density; and
performing distortion compensation on the second image.

18. The method of claim 17, wherein the region of increased pixel density in the compensated second image corresponds to the object of interest.

19. The method of claim 17, further comprising:
in response to determining that the region of increased pixel density within the second image does not align with the object of interest, adjusting an orientation of a second camera and acquiring a third image with the second camera wherein in the third image, the region of increased pixel density aligns with the object of interest; and
performing distortion compensation on the third image instead of the second image.

20. The method of claim 14, further comprising further processing the one or more compensated images, wherein further processing the one or more compensated images comprises determining one or more driver or occupant parameters, and determining a drowsiness level and/or an attention level of the driver or occupant of the vehicle based on the driver or occupant parameters, wherein a potentially dangerous situation is identified if the drowsiness level exceeds a defined threshold and/or if the attention level falls below a defined threshold.
